(19) United States
(12) Patent Application Publication
(10) Pub. No.: US 2005/0267779 A1
(43) Pub. Date: Dec. 1, 2005

(54) Method, apparatus, and medium for servicing clients in remote areas

(75) Inventors: Hak-goo Lee, Suwon-si (KR); Min-Jae Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/139,604

(22) Filed: May 31, 2005

(30) Foreign Application Priority Data
May 31, 2004 (KR) 2004-39241

(51) Int. Cl. G06F 17/60

(52) U.S. Cl. 705/1; 705/26

(57) ABSTRACT

A remote control apparatus, method, and medium for enabling a server to control a plurality of clients located in remote areas is provided. The method includes: switching an environment of a server by loading display information stored in one of a plurality of backup buffers in a display processing module of the server; and transmitting the display information to one of the plurality of clients if there is a request for the display information issued by the one of the plurality of clients. Accordingly, it is possible to enable the plurality of clients to be simultaneously served by the server, regardless of which types of remote control protocols and which types of OSs the plurality of clients use, by repeatedly performing interrupt service routines for backing up display information of the plurality of clients to the respective backup buffers or loading the display information of the plurality of clients into the server.

### CROSS-REFERENCE TO RELATED APPLICATIONS

This application claims the benefit of Korean Patent Application No. 10-2004-0039241, filed on May 31, 2004, in the Korean Intellectual Property Office, the disclosure of which is incorporated herein in its entirety by reference.

### BACKGROUND OF THE INVENTION

1. Field of the Invention

The present invention relates to a remote control apparatus and method, and more particularly, to a remote control apparatus and method, which enables a user to control a server in remote areas.

2. Description of the Related Art

There are protocols, such as remote frame buffer (RFB) and remote desktop protocol (RDP), which enable a server to control a plurality of clients located in remote areas. RFB and RDP enable a user to use output and input apparatuses of a computer in a remote area as if the computer were in the user's vicinity by realizing display information of a server in a remote area in a client in the user's vicinity via a network.

RFB realizes the display information of the server in the client by copying display information stored in a frame buffer of a graphic card of the server to a frame buffer of a graphic card of the client. RDP is based on the existing International Telecommunications Union-Telecommunication Standardization Sector (ITU-T) 120 family of standards. In other words, RDP realizes the display information of the server in the client by enabling the server to transmit object information of operating systems (OSs) specified by the ITU-T standards and enabling the client to receive the object information of the OSs and process the received object information according to the ITU-T standards.

As described above, RDP is dependent on OSs. Since the OSs specify different information types, RDP cannot realize the display information of the server in the client if the server and the client use different types of OSs. On the other hand, RFB can realize the display information of the server in the client regardless of whether the server and the client use the same OS because it directly copies the display information stored in the frame buffer of the graphic card of the server to the frame buffer of the graphic card of the client in a lower level than RDP. According to RFB, however, the client cannot be serviced by the server when the server is busy servicing another client, because one client occupies one frame buffer.

### SUMMARY OF THE INVENTION

Additional aspects and/or advantages of the invention will be set forth in part in the description which follows and, in part, will be obvious from the description, or may be learned by practice of the invention.

The present invention provides a method and apparatus for servicing a plurality of clients in remote areas, which enable a plurality of clients to be simultaneously served by a server regardless of which types of remote control protocols and/or which types of operating systems they use.

According to an aspect of the present invention, there is provided a method of servicing a plurality of clients in remote areas. The method includes: (a) switching an environment of a server by loading display information stored in one of a plurality of backup buffers in a display processing module of the server; and (b) transmitting the display information to one of the plurality of clients if there is a request for the display information issued by the one of the plurality of clients.

According to another aspect of the present invention, there is provided a server which services a plurality of clients in remote areas. The server includes: a server environment switch unit, which switches an environment of a server by loading display information stored in one of a plurality of backup buffers in a display processing module of the server; and a display information transmission unit, which transmits the display information to one of the plurality of clients if there is a request for the display information issued by the one of the plurality of clients.

According to another aspect of the present invention, there is provided a method of switching an environment of a server. The method includes: (a) copying display information of a first client, stored in a first backup buffer, to a display processing module of the server, the first backup buffer being one of a plurality of backup buffers of the server; and (b) switching the environment of the server to a user environment of the first client based on the display information of the first client stored in the display processing module. Here, the first client is one of a plurality of clients that are served by the server and are located in remote areas.

According to another aspect of the present invention, there is provided an apparatus for switching an environment of a server. The apparatus includes: a display information copy unit, which copies display information of a first client, stored in a first backup buffer, to a display processing module of the server, the first backup buffer being one of a plurality of backup buffers of the server; and a user switch unit, which switches the environment of the server to a user environment of the first client based on the display information of the first client stored in the display processing unit. Here, the first client is one of a plurality of clients that are served by the server and are located in remote areas.

According to another aspect of the present invention, there is provided at least one computer-readable medium storing instructions that control at least one processor to perform a method of servicing a plurality of clients in remote areas is recorded. The method includes: (a) switching an environment of a server by loading display information stored in one of a plurality of backup buffers in a display processing module of the server; and (b) transmitting the display information to one of the plurality of clients if there is a request for the display information issued by the one of the plurality of clients.

According to another aspect of the present invention, there is provided at least one computer-readable medium storing instructions that control at least one processor to perform a method of switching an environment of a server is recorded. The method includes: (a) copying display information of a first client, stored in a first backup buffer, to a display processing module of the server, the first backup buffer being one of a plurality of backup buffers of the server; and (b) switching the environment of the server to a user environment of the first client based on the display information of the first client stored in the display processing module. Here, the first client is one of a plurality of clients that are served by the server and are located in remote areas.

### BRIEF DESCRIPTION OF THE DRAWINGS

These and/or other aspects, features and advantages of the present invention will become more apparent and more readily appreciated from the following description of exemplary embodiments, taken in conjunction with the accompanying drawings of which:

FIG. 1 is a diagram illustrating a remote control environment according to an exemplary embodiment of the present invention;

FIG. 2 is a block diagram of a server according to an exemplary embodiment of the present invention;

FIG. 3 is a detailed block diagram of a server environment switch unit 215 of FIG. 2;

FIG. 4 is a diagram illustrating a T.120 stack;

FIG. 5 is a diagram illustrating various operating systems (OSs) supported by T.120;

FIG. 6 is a flowchart of a method of servicing a plurality of clients in remote areas according to an exemplary embodiment of the present invention; and

FIG. 7 is a detailed flowchart of operation 67 of FIG. 6.

### DETAILED DESCRIPTION OF THE PREFERRED EMBODIMENTS

Reference will now be made in detail to the exemplary embodiments of the present invention, examples of which are illustrated in the accompanying drawings, wherein like reference numerals refer to the like elements throughout. The exemplary embodiments are described below to explain the present invention by referring to the figures.

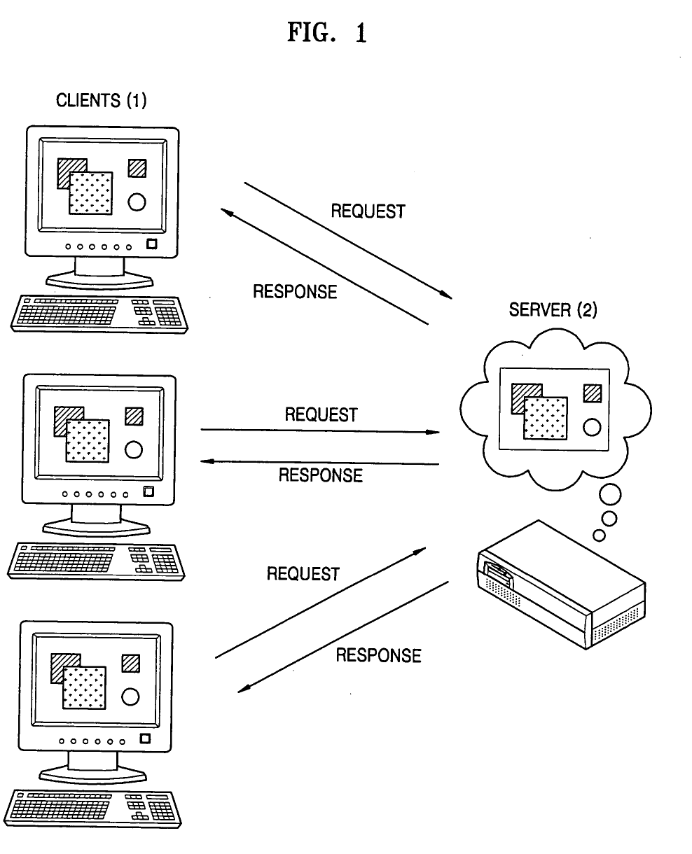

FIG. 1 is a diagram illustrating a remote control environment according to an exemplary embodiment of the present invention. Referring to FIG. 1, the remote control environment consists of a plurality of clients 1, which are located in remote areas, and a server 2, which services the plurality of clients 1. The plurality of clients 1 issue various requests for processing their operations to the server 2, and the server 2 processes the various requests and transmits appropriate responses, i.e., the processing results, to the plurality of clients 1. In the present embodiment, the plurality of clients 1 uses different remote control protocols and different operation systems from one another.

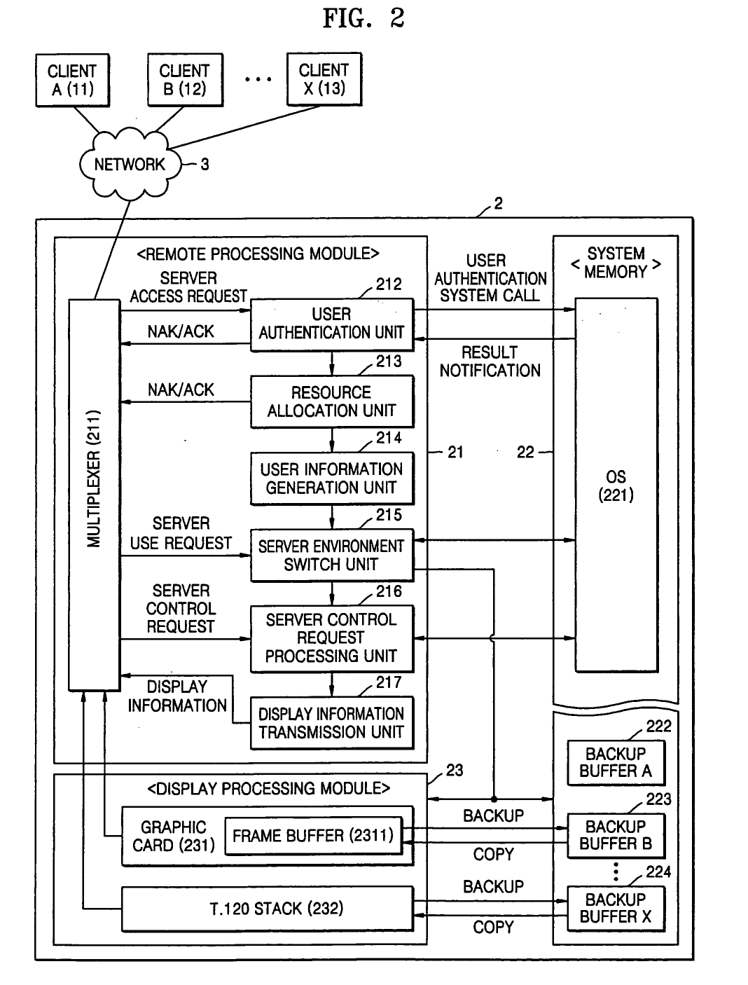

FIG. 2 is a block diagram of a server 2 according to an exemplary embodiment of the present invention. Referring to FIG. 2, the server 2 includes a remote processing module 21, a system memory 22, and a display processing module 23. The server 2 may include other elements, which are not shown. However, for the convenience, only those elements, which are closely related to the concept of the present invention, are illustrated in FIG. 2.

The remote processing module 21 of server 2 receives various requests issued by clients A (11), B (12), and X (13), which are located in remote areas, and processes the received requests. The remote processing module 21 may receive the various requests issued by the clients A(11), B(12), and X(13) by way of a network 3.

The system memory 22 for a computer stores operating systems (OSs), application programs, and data currently being processed by the server 2. For convenience, only an OS 221 and backup buffers A (222), B (223), and X (224) are illustrated in FIG. 2 as if they were the only elements of the system memory 22, but the system memory 22 may further include elements other than those elements illustrated in FIG. 2. FIG. 2 illustrates an occasion when the OS 221 is loaded from a hard disk (not shown) into the system memory 22 through booting.

The display processing module 23 processes display-associated operations under control of the remote processing module 21. The display processing module 23 is composed of a frame buffer 2311 in a graphic card 231 of the server 2 and a T.120 stack 232 in a protocol stack of the server 2.

The remote processing module 21 includes a multiplexer 211, a user authentication unit 212, a resource allocation unit 213, a user information generation unit 214, a server environment switch unit 215, a server control request processing unit 216, and a display information transmission unit 217. The remote processing module 21 is designed for universal use, regardless of which types of remote control protocols and which types of operating systems the clients A (11), B (12), and X (13) use. Here, each of the clients A (11), B (12), and X (13) may use remote frame buffer (RFB) or remote desktop protocol (RDP) as a remote control protocol.

The multiplexer 211 receives requests issued and then multiplexed by the clients A (11), B (12), and X (13) via a network, demultiplexes the received requests, and outputs the demultiplexed requests to other elements in the remote processing module 21. In addition, the multiplexer 211 multiplexes responses output from the other elements in the remote processing module 21 and transmits the multiplexed responses to the clients A (11), B (12), and X (13) via the Internet. Here, the network 3 may denote the Internet.

When the user authentication unit 212 receives a server access request from any one of the clients A (11), B (12), and X (13) via the multiplexer 211, it authenticates a user of the client that has issued the server access request to the server 2. The server access request contains user account information and remote control protocol information and can be manually made by any of the clients A (11), B (12), and X (13) with the use of an input device, such as a keyboard, a touch screen or a mouse, or can be automatically made when the corresponding client is powered on.

More specifically, the user authentication unit 212 authenticates the user of the client that has issued the server access request to the server 2 by determining whether the user's account exists in a user account database of the server through system call using the OS 221, which is associated with user authentication. If the user of the client that has issued the server access request to the server 2 is determined to be an unauthorized user, in other words, if the user's account is determined not to exist in the user account database of the server 2, the user authentication unit 212 transmits a negative acknowledgement (NAK) message to the corresponding client via the multiplexer 211. On the other hand, if the user of the client that has issued the server access request to the server 2 is determined to be an authorized user, in other words, if the user's account is determined to exist in the user account database of the server 2, the user authentication unit 212 transmits an acknowledgement (ACK) message to the corresponding multiplexer 211.

The resource allocation unit 213 allocates resources of the server 2 yet to be allocated to the clients A (11), B (12), and X (13) if the clients A (11), B (12), and X (13) have been successfully authenticated by the user authentication unit 212. More specifically, the resource allocation unit 213 determines whether the resources of the server 2 yet to be allocated are sufficient enough to be allocated to a client that has just been successfully authenticated by the user authentication unit 212. If the resources of the server 2 yet to be allocated are sufficient enough to be allocated to the client, the resource allocation unit 213 transmits an acknowledgement (ACK) message to the client and allocates the resources of the server 2 yet to be allocated to the client. Otherwise, the resource allocation unit 213 transmits an NAK message to the client. Here, the resources of the server 2 denote sessions and the backup buffers A (222), B (223), and X (224). In short, the resource allocation unit 213 allots the resources of the server yet to be allocated, i.e., sessions and the backup buffers A (222), B (223), and X (224), to the clients A (11), B (12), and X (13) if the clients A (11), B (12), and X (13) have been successfully authenticated by the user authentication unit 212.

The user information generation unit 214 generates user information, which includes the user account information and the remote control protocol information included in the server access request, and allocated resource information. Here, the allocated resource information includes session information (e.g., serial numbers of ports allocated to the clients A (11), B (12), and X (13)) and the backup buffer information (e.g., start addresses of the backup buffers A (222), B (223), and X (224) allotted to the clients A (11), B (12), and X (13)).

When the server environment switch unit 215 receives a server use request from any of the clients A (11), B (12), and X (13) that has received the ACK message from the server 2 via the multiplexer 211, it switches an environment of the server 2 from an environment of a client currently being serviced by the server 2 to an environment of the client that has issued the server use request to the server 2. Here, the client that has issued the server use request to the server 2 has already been successfully authenticated by the user authentication unit 212 and has already been allocated some of the resources of the server 2 by the resource allocation unit 213. The server use request can be manually made by any of the clients A (11), B (12), and X (13) with the use of a keyboard or a mouse or can be automatically made when the user information generation unit 214 generates the user information.

More specifically, the server environment switch unit 215 switches the environment of the server 2 by backing up display information of one of the clients A (11), B (12), and X (13) that is currently being served by the server 2 to a corresponding backup buffer and loads display information of another one of the clients A (11), B (12), and X (13) that has issued the server use request to the server 2 into the display processing module 23.

The server 2 backs up display information of the clients A (11), B (12), and X (13) to the backup buffers A (222), B (223), and X (224) so that it can simultaneously service the clients A (11), B (12), and X (13). In the present embodiment, the server environment switch unit 215 is realized as interrupt service routines in order to smoothly service the clients A (11), B (12), and X (13). In other words, when the server environment switch unit 215 receives an interrupt signal, which is generated whenever any of the clients A (11), B (12), and X (13) issues a server use request, the server environment switch unit 215 switches the environment of the server 2. Here, the display information denotes window information displayed on a display device of each of the clients A (11), B (12), and X (13).

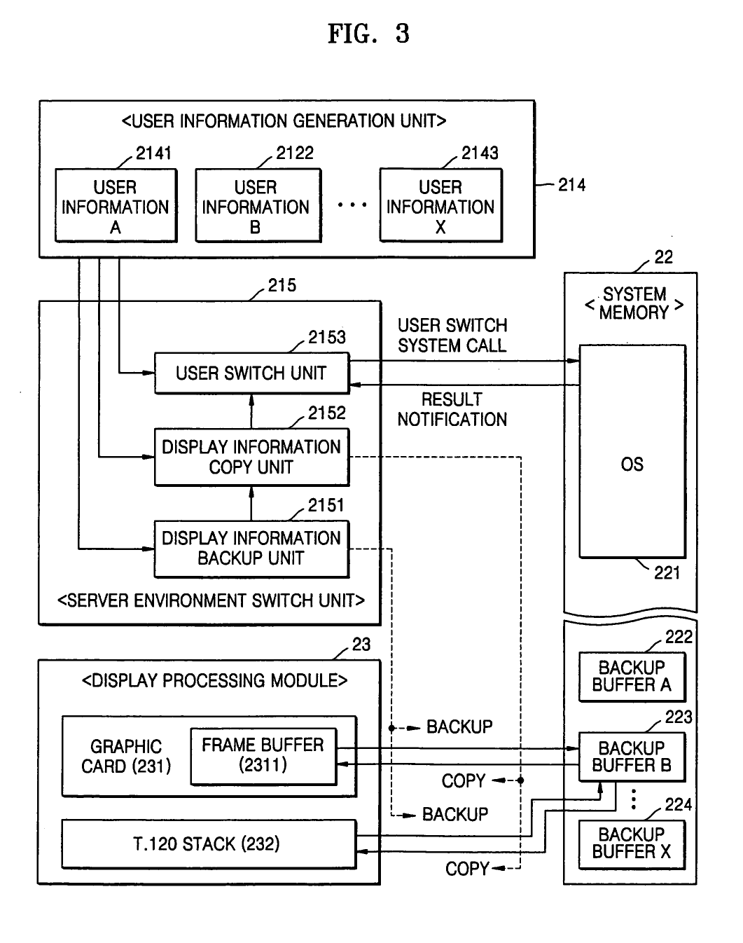

FIG. 3 is a detailed block diagram of the server environment switch unit 215 of FIG. 2. Referring to FIG. 3, the server environment switch unit 215 includes a display information backup unit 2151, a display information copy unit 2152, and a user switch unit 2153. The display information backup unit 2151, the display information copy unit 2152, and the user switch unit 2153 correspond to interrupt service routines, which are initiated in response to an interrupt signal. Hereinafter, it will be assumed that the client A (11) is currently being served by the server 2, and the client B (12) has just issued a server use request to the server 2.

The display information backup unit 2151 backs up display information of the client A (11), which is stored in the display processing module 23, to the backup buffer A (222) allocated thereto with reference to user information A (2141) of the client A (11), which is generated by the user information generation unit 214. More specifically, the display information backup unit 2151 recognizes the backup buffer A (222) by referring to a start address of the backup buffer A (222) included in the user information A and backs up the display information of the client A (11) to the backup buffer A (222). As a result, the client A (11) can consecutively process operations that used to be processed in a previous server usage session even in a subsequent sever usage session by using the display information of the client A (11) stored in the backup buffer A 222.

Once the display information backup unit 2152 completes backing up the display information of the client A (11) to the backup buffer A (222), the display information copy unit 2152 copies display information of the client B (12), which is stored in the backup buffer B (223), to the display processing module 23 with reference to user information B (2142) of the client B (12), which is one of a plurality of user information generated by the user information generation unit 214. More specifically, the display information copy unit 2152 recognizes the backup buffer B (223) with reference to a start address of the backup buffer B (223) included in the user information B (2142) and then copies the display information of the client B (12) to the display processing module 23.

The display information copy unit 2152 determines whether the client B (12) uses RFB or RDP by referring to remote control protocol information included in the user information B (2142). If the client B (12) is determined to use RFB, the display information of the client B (12) stored in the backup buffer B (223) is copied to a frame buffer 2311 of a graphic card 231 in the display processing module 23. On the other hand, if the client B (12) uses RDP, the display information of the client B (12) stored in the backup buffer B (223) is copied to a T.120 stack 232 in the display processing module 23. As a result, the display processing module 23 becomes ready to serve the client B (12). In the present exemplary embodiment, it is determined whether the display information of the client B (12) stored in the backup buffer B (223) is to be copied to the frame buffer 2311 or to the T.120 stack 232 by referring to the remote control protocol information included in the corresponding display information of the client B (12). Therefore, it is possible to enable a plurality of clients having different remote control protocols to be served by a single server. It is also understood that the other backup buffers function in a similar manner.

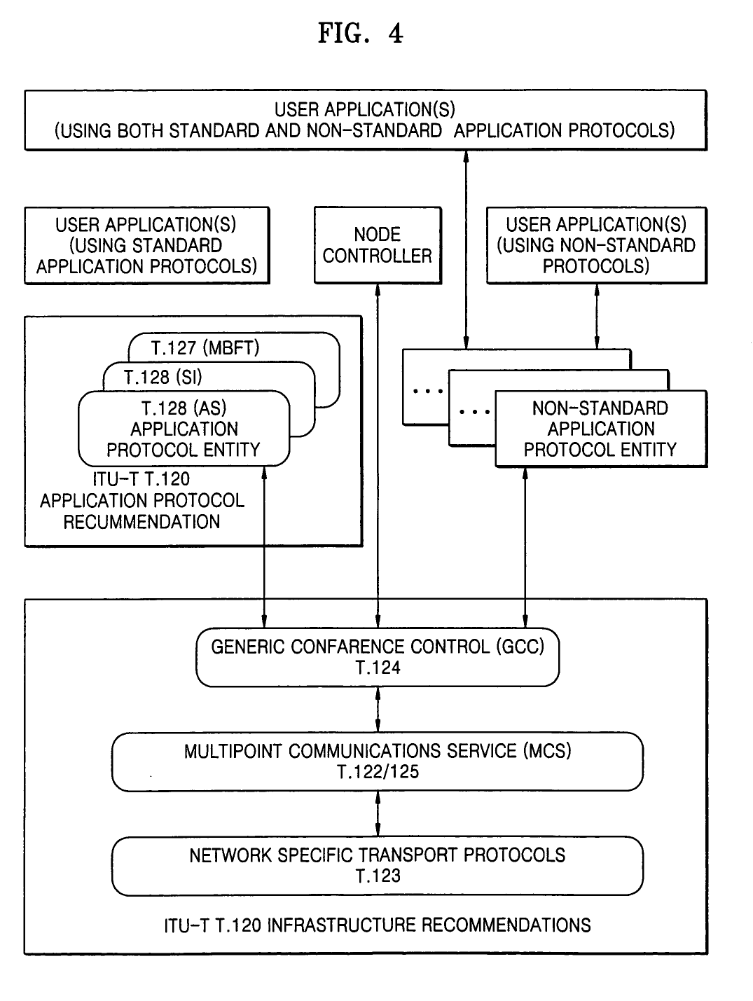

FIG. 4 is a diagram illustrating T.120. Referring to FIG. 4, T.121 (a generic application template) regulates a common architecture for T.120 application programs. T.122 (multipoint communication services) describes the definition of T.123 network services realized under T.125. T.123 (audiovisual protocol stacks) regulates protocol layers for terminals and multipoint control units (MCUs). T.124 (general conference control) regulates the initiation and administration of multipoint data conferences. T.125 regulates multipoint communication services defined by T.122. T.126 (still images & annotation protocols) regulates how an application sends or receives whiteboard information or graphic images. T.127 (multipoint binary file transfer) regulates how files are simultaneously transmitted among multiple end points. T.128 (audio visual control) regulates routing, identification of multipoint end points, remote control, and medium selection.

T.120 is an International Telecommunication Union-Telecommunication Standardization Sector (ITU-T) standard which is made up of a suite of communication and application protocols defining every aspect of video conferencing and enables multiple users to participate in conferencing sessions over different types of networks and connections. As shown in FIG. 4, a T.120 stack is a middleware between an application layer and a network layer. Elements of the T.120 stack enable display information to be transmitted by supporting application program interfaces (APIs) in the application layer.

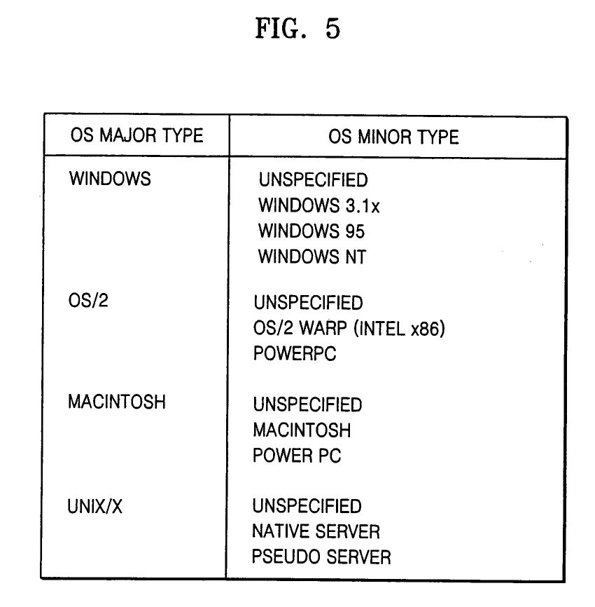

FIG. 5 is a diagram illustrating various OSs supported by T.120. Referring to FIG. 5, T.120 supports various OSs that are currently available, such as Windows, OS/2, Macintosh, and UNIX/X. Elements of T.120 contain information on the various OSs to receive or transmit display information, and the information on the various OSs has been standardized by the ITU-T. In other words, the server 2 transmits object information of the various OSs defined by ITU-T standards to the clients 1. The clients 1 receive the object information of the various OSs and generates a display environment appropriate for each of the various OSs by processing the received object information according to the ITU-T standards. As described above, in the present embodiment, it is possible to enable the clients 1 to be served by the server 2 by backing up the object information of the various OSs to the backup buffers A (222), B (223) and X (224) allocated to the clients 1 and then loading the object information backed up to the backup buffers A (222), B (223) and X (224).

Referring to FIG. 3, when the display information copy unit 2152 completes the copying of the display information of the client B (12), which has been backed up to the backup buffer B (223), to the display processing module 23, the user switch unit 2153 switches the environment of the server 2 from a user environment of the client A (11) to a user environment of the client B (12) with reference to the display information of the client B (12) stored in the display processing module 23. More specifically, the user switch unit 2153 switches the environment of the server 2 from the user environment of the client A (11) to the user environment of the client B (12) through system call using the OS 221, which is associated with ‘user switch’.

The environment of the server 2 is switched from the user environment of the client A (11) to the user environment of the client B (12) through ‘user switch’. For example, when the server 2 receives a server use request issued by a user of the client B (12) while a user of the client A (11) performs a web browsing operation, the server 2 calls an interrupt service routine for switching the environment of the server 2 and then performs the interrupt service routine. As a result, the environment of the server 2 is switched to the state of a compile operating that has been performed by the client B (12). In this case, the user of the client B (12) must have a higher priority level than the user of the client A (12). Since the present exemplary embodiment generally relates to a remote control protocol, detailed description of operations associated with the OS 221, such as priorities among a plurality of clients or processing of requests of the plurality of clients according to their respective priority levels, is not further discussed.

Referring to FIG. 2, the server control request processing unit 216 receives various server control requests from a client currently being served by the server 2, i.e., from the client B (12), via the multiplexer 211. If the various server control requests are associated with the control of the OS 221, the server control request processing unit 216 controls the OS 221 in response to the various server control requests. On the other hand, if the various server control requests are associated with the control of the display processing module 23, the server control request processing unit 216 controls the display processing module 23 in response to the various server control requests. The various server control requests are generated by the user of the client B (12) with the use of an input device, such as a keyboard, a touch screen, or a mouse.

If the server control request processing unit 216 receives a server control request, i.e., a display information request, from the client B (12), it issues a command to transmit the display information of the client B (12) stored in the display processing module 23 to the client B (12).

The display information transmission unit 217 transmits the requested display information to the client B (12) in response to the command issued by the server control request processing unit 216. More specifically, if the client B (12) uses RFB, the display information transmission unit 217 transmits the display information stored in the frame buffer 2311 to the client B (12). On the other hand, if the client B (12) uses RDP, the display information transmission unit 217 transmits the display information stored in the T.120 stack 232 to the client B (12).

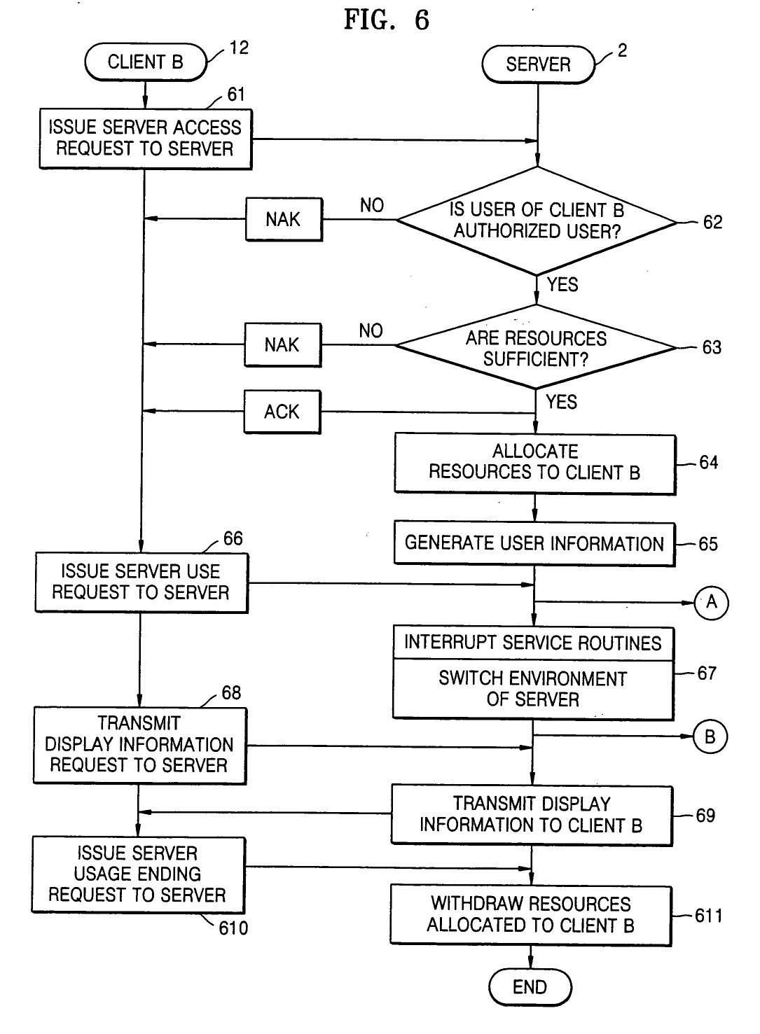

FIG. 6 is a flowchart of a method of servicing a plurality of clients in remote areas according to an exemplary embodiment of the present invention. The method of servicing a plurality of clients in remote areas is performed in the server 2 of FIG. 2. Therefore, those which have been described above with reference to FIG. 2 are directly applied to the present exemplary embodiment. It is assumed that the client A (11) is currently being served by the server 2, and the client B (12) attempts to access the server 2 to be served by the server 2.

Referring to FIGS. 2, 3, and 6, in operation 61, the client B (12) issues a server access request to the server 2. In operation 62, the server 2 receives the server access request from the client B (12) and authenticates the user of the client B (12). More specifically, in operation 62, the server 2 authenticates the user of the client B (12) by determining whether the user of the client B (12) has an account registered with the server 2 through system call with the use of the OS 221. The server access request includes user account information and remote control protocol information. The server access request may be manually generated by the user of the client B (12) using a keyboard or a mouse or may be automatically generated when the client B (12) is powered on. If the user of the client B (12) is determined to be an unauthorized user, the server 2 transmits a NAK message to the client B (12).

On the other hand, if the user of the client B (12) is determined to be an authorized user, the server 2 determines whether its resources yet to be allocated are sufficient enough to be allocated to the client B (12) in operation 63. If the resources yet to be allocated are sufficient enough to be allocated to the client B (12), the server 2 transmits an ACK message to the client B (12) and allocates its resources to the client B (12) in operation 64. Otherwise, the server 2 transmits a NAK message to the client B (12). Here, resources denote sessions and backup buffers. In other words, in operation 64, the server 2 allocates a session and a backup buffer to the client B (12).

In operation 65, user information B (2142), which includes the user account information and the remote control protocol information contained in the server access request, and information on the resources allocated to the client B (12) in operation 64, is generated. Here, the information on the resources allocated to the client B (12) denotes session information, such as a serial number of a port allocated to the client B (12), and backup buffer information, such as a start address of the backup buffer allocated to the client B (12).

In operation 66, the client B (12), which has received the ACK message from the server 2, issues a server use request to the sever 2. In operation 67, the server 2 receives the server use request from the client B (12) and generates an interrupt signal in order to initiate an interrupt service routine for switching the environment of the server 2. The environment of the server 2 is switched from the user environment of the client A (11) to the environment of the client B (12) by performing the interrupt service routine with reference to the user information B (2142) generated in operation 65. The server use request issued may be manually generated by the user of the client B (12) with the use of a keyboard or a mouse or may be automatically generated when the user information B (2142) is generated in operation 65.

More specifically, in operation 67, the server 2 backs up display information of the client A (222), which is currently being processed by the display processing module 23, to the backup buffer A (222) and then loads display information of the client B (12) stored in the backup buffer B (223) into the display processing module 23, thereby switching the environment of the server 2 from the user environment of the client A (11) to the user environment of the client B (12). Here, the display information denotes window information displayed on a display device of the client A (11) or B (12).

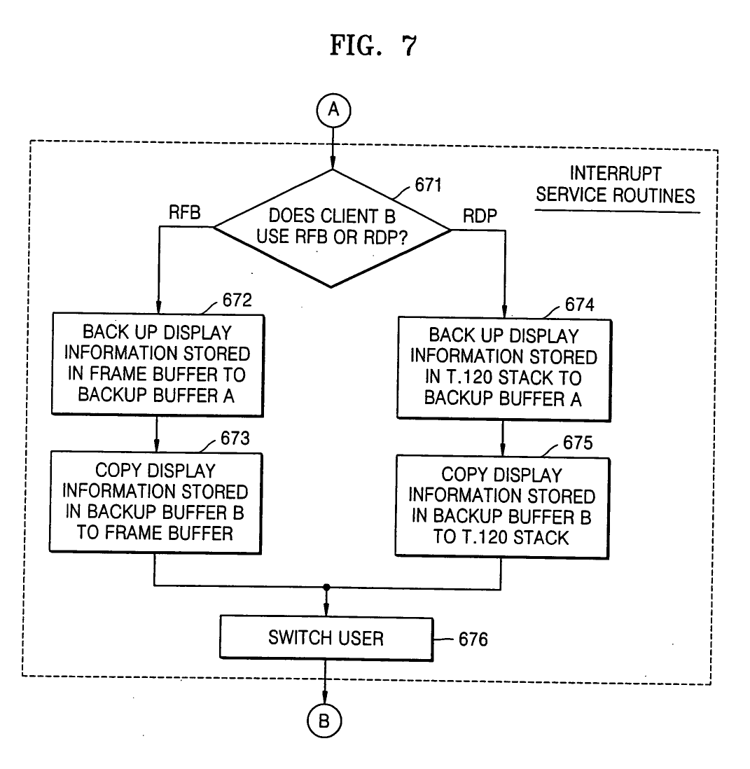

FIG. 7 is a detailed flowchart of operation 67 of FIG. 6. Referring to FIG. 7, operations 671 through 676 are interrupt service routines which are initiated in response to an interrupt signal.

In operation 671, the server 2 determines whether the client B (12) uses RFB or RDP by referring to the remote control protocol information included in the user information B 2142. If the client B (12) uses RFB, the server 2 backs up the display information of the client A 11 stored in the frame buffer 2311 of the graphic card 231 in the display processing module 23 to the backup buffer A (222) allocated to the client A (11) in operation 672. More specifically, the server 2 recognizes the backup buffer A (222) with reference to a start address of the backup buffer A (222) included in the user information A (2141) and backs up the display information of the client A (11) to the backup buffer A (222).

Thereafter, in operation 673, the server 2 copies the display information of the client B (12) stored in the backup buffer B (223) to the frame buffer 2311 of the graphic card 231 n the display processing module 23 in operation 673. More specifically, in operation 673, the server 2 recognizes the backup buffer B (223) with reference to a start address of the backup buffer B (223) included in the user information B (2142) and copies the display information of the client B (12) stored in the backup buffer B (223) to the frame buffer 2311 of the graphic card 231 in the display processing module 23.

On the other hand, if the client B (12) uses RDP, the server 2 backs up the display information of the client A (11) stored in the T.120 stack 232 in the display processing module 23 to the backup buffer A (222) with reference to the user information A (2141) of the client A (11) in operation 674. More specifically, in operation 674, the server 2 recognizes the backup buffer B (223) with reference to the start address of the backup buffer B (223) included in the user information B (2142) and copies the display information of the client B (12) stored in the backup buffer B (223) to the T.120 stack 232 in the display processing module 23.

In operation 676, the environment of the server 2 is switched from the user environment of the client A (11) to the user environment of the client B (12) based on the display information of the client B (12) stored in the frame buffer 2311 or in the T.120 stack 232. More specifically, in operation 676, the environment of the server 2 is switched from the user environment of the client A (11) to the user environment of the client B (12) through system call by using the OS 221, which is associated with ‘user switch’.

The server 2 now receives various server control requests from the client B (12). If the various server control requests are associated with the control of the OS 221, the server 2 controls the OS 221 in response to the various server control requests. On the other hand, if the various server control requests are associated with the control of the display processing module 23, the server 2 controls the display processing module 23 in response to the various server control requests. The various server control requests are generated by the user of the client B (12) with the use of an input device such as a keyboard, a touch screen, or a mouse.

Referring to FIG. 6, in operation 68, the client B (12) transmits a display information request to the server 2. The display information request is one of various server control requests issued to the server 2 by the client B (12).

In operation 69, the server 2 receives the display information request from the client B (12) and then transmits the display information of the client B (12) stored in the display processing module 23 to the client B (12). More specifically, if the client B (12) uses RFB, the server 2 transmits the display information stored in the frame buffer 2311 to the client B (12). On the other hand, if the client B (12) uses RDP, the server 2 transmits the display information stored in the T.120 stack 232 to the client B (12).

In operation 610, the client B (12) issues a server usage ending request to the server 2. The server usage end request is another one of the various server control requests issued to the server 2 by the client B (12).

In operation 611, the server 2 receives the server usage ending request from the client B (12) and withdraws the resources (i.e., the session and the backup buffer B (223)) allocated to the client B (12), thereby making more of its resources available for other clients.

The present invention can be realized as a computer program written on a computer-readable recording medium, so that it can be executed in a universal digital computer or any other computing device with the help of the computer-readable recording medium.

Exemplary embodiments of the present invention have been described herein with reference to flowchart illustrations of methods according to exemplary embodiments of the present invention. It is be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus to implement the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture to implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

In addition, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

In addition, data structures adopted in the exemplary embodiments of the present invention can be recorded on the computer-readable recording medium in various manners.

Examples of a computer-readable recording medium include a magnetic storage medium (e.g., a ROM, a floppy disk, or a hard disk), an optical storage medium (e.g., a CD-ROM or a DVD), and a carrier wave or digital transmission medium (e.g., data transmissions through the Internet).

Examples of the computer-readable medium further include any type of transmission medium including any type of transmission medium including networks, which may be wired networks, wireless networks or any combination thereof. The computer-readable medium may be referred to as a medium, and the medium may be distributed among computing devices as part of one or more networks or coupled with one or more networks.

One or more computing devices may be mobile nodes, i.e., mobile terminals, enabling users to access a server or network such as the Internet. The mobile nodes include laptop computers, web pads, hand-held PCs, personal digital assistants (PDAs), cellular phones, and so on.

According to the present invention, it is possible to enable a plurality of clients to be simultaneously served by a server, regardless of which types of remote control protocols and which types of OSs the plurality of clients use, by repeatedly performing interrupt service routines for backing up display information of the plurality of clients to the respective backup buffers or loading the display information of the plurality of clients into the server.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

1. A method of servicing a plurality of clients in remote areas, the method comprising:
(a) switching an environment of a server by loading display information stored in one of a plurality of backup buffers in a display processing module of the server; and
(b) transmitting the display information to one of the plurality of clients if there is a request for the display information issued by the one of the plurality of clients.

2. The method of claim 1, wherein the display information is window information displayed on a display device of the one of the plurality of clients that has issued the request for the display information.

3. The method of claim 1, wherein in (a), display information currently being processed by the display processing module is backed up to another one of the plurality of backup buffers, and then the display information stored in the one of the plurality of backup buffers is loaded in the display processing module.

4. The method of claim 1, wherein in (a), when an interrupt signal is generated in response to a server use request issued by the one of the plurality of clients, the environment of the server is switched.

5. The method of claim 1 further comprising:
(c) authenticating a user of the one of the plurality of clients,
wherein in (a), the environment of the server is selectively switched depending on the authentication result.

6. The method of claim 1 further comprising:
allocating resources of the server yet to be allocated to the one of the plurality of clients,
wherein in (a), the environment of the server is switched based on the resources allocated to the one of the plurality of clients.

7. A server which services a plurality of clients in remote areas, the server comprising:
a server environment switch unit, which switches an environment of the server by loading display information stored in one of a plurality of backup buffers in a display processing module of the server; and
a display information transmission unit, which transmits the display information to one of the plurality of clients if there is a request for the display information issued by the one of the plurality of clients.

8. The server of claim 7, wherein the display information is window information displayed on a display device of the one of the plurality of clients that has issued the request for the display information.

9. The server of claim 7, wherein the server environment switch unit backs up display information currently being processed by the display processing module to another one of the plurality of backup buffers and then loads the display information stored in the one of the plurality of backup buffers in the display processing module.

10. The server of claim 7, wherein the server environment switch unit switches the environment of the server when an interrupt signal is generated in response to a server use request issued by the one of the plurality of clients.

11. A method of switching an environment of a server, comprising:
(a) copying display information of a first client, stored in a first backup buffer, to a display processing module of the server, the first backup buffer being one of a plurality of backup buffers of the server; and
(b) switching the environment of the server to a user environment of the first client based on the display information of the first client stored in the display processing module,
wherein the first client is one of a plurality of clients that are served by the server and are located in remote areas.

12. The method of claim 11 further comprising:
(c) backing up display information of a second client, stored in the display processing module, to a second backup buffer, the second backup buffer being another one of the plurality of backup buffers,
wherein the second client is another one of the plurality of clients.

13. The method of claim 12, wherein in (c), once the display information of the second client is backed up to the second backup buffer, the display information of the first client is copied to the display processing module in (a), and in (b), the environment of the server is switched from a user environment of the second client to the user environment of the first client.

14. The method of claim 11, wherein in (a), the display information of the first client is copied to a frame buffer in the display processing module or to a T.120 stack in the display processing module depending on which type of remote control protocol the first client uses.

15. The method of claim 14, wherein the remote control protocol that the first client uses is one of remote frame buffer (RFB) and remote desktop protocol (RDP).

16. An apparatus for switching an environment of a server, comprising:
a display information copy unit, which copies display information of a first client, stored in a first backup buffer, to a display processing module of the server, the first backup buffer being one of a plurality of backup buffers of the server; and
a user switch unit, which switches the environment of the server to a user environment of the first client based on the display information of the first client stored in the display processing module,
wherein the first client is one of a plurality of clients that are served by the server and are located in remote areas.

17. The apparatus of claim 16 further comprising:
a display information backup unit, which backs up display information of the second client, stored in the display processing module, to a second backup buffer, the second backup buffer being another one of the plurality of backup buffers,
wherein the second client is another one of the plurality of clients.

18. At least one computer-readable medium storing instructions that control at least one processor to perform a method of servicing a plurality of clients in remote areas is recorded, the method comprising:
(a) switching an environment of a server by loading display information stored in one of a plurality of backup buffers in a display processing module of the server; and
(b) transmitting the display information to one of the plurality of clients if there is a request for the display information issued by the one of the plurality of clients.

19. At least one computer-readable medium storing instructions that control at least one processor to perform a method of switching an environment of a server is recorded, the method comprising:
(a) copying display information of a first client, stored in a first backup buffer, to a display processing module of the server, the first backup buffer being one of a plurality of backup buffers of the server; and
(b) switching the environment of the server to a user environment of the first client based on the display information of the first client stored in the display processing module,
wherein the first client is one of a plurality of clients that are served by the server and are located in remote areas.

20. The at least one computer-readable medium of claim 18, wherein in (a), an interrupt signal is generated in response to a server use request issued by the one of the plurality of clients, the environment of the server is switched.
